(19) United States
(12) Patent Application Publication
(10) Pub. No.: US 2017/0101054 A1
(43) Pub. Date: Apr. 13, 2017

(54) INTER-VEHICLE COMMUNICATION FOR ROADSIDE ASSISTANCE

(71) Applicant: Harman International Industries, Incorporated, Stamford, CT (US)

(72) Inventor: Yogesh Devidas Dusane, Nashik (IN)

(21) Appl. No.: 14/878,981

(22) Filed: Oct. 8, 2015

(51) Int. Cl. B60Q 9/00; G08G 1/127

(52) U.S. Cl. CPC B60Q 9/00; G08G 1/127

(57) ABSTRACT

Embodiments are disclosed for an example inter-vehicle communications system. The example inter-vehicle communications system includes a plurality of vehicles, each of the vehicles equipped with: a transceiver capable of sending and receiving wireless signals, a display screen, a processor, and a storage device storing instructions executable by the processor to in a first mode, generate and transmit an alert via the transceiver in response to detecting an alert condition, and in a second mode, display a received alert to a vehicle user via the display screen in response to receiving the received alert via the transceiver.

### FIELD

The disclosure relates to the field of on-road assistance systems, and in particular to emergency assistance systems operable to notify nearby vehicles in the event of an impact or medical emergency.

### BACKGROUND

Emergency assistance systems are known for transmitting vehicle information in the event of an impact. These systems are designed such that upon detecting an impact situation, a telephone call or SMS message may be initiated to a base station. The emergency system sends vehicle information, such as vehicle crash data, vehicle identification, vehicle condition, and vehicle location information to the base station. Thus, emergency units such as ambulances and/or police may be automatically called in the event of an impact. However, when driving in locations without cellular reception the vehicle may be unable to notify emergency units in the event of an impact, accident, or mechanical failure of the vehicle.

### SUMMARY

Embodiments are disclosed for an example on-road assistance system for a vehicle. The example inter-vehicle communications system includes a plurality of vehicles, each of the vehicles equipped with a transceiver capable of sending and receiving wireless signals. Each of the vehicles in the inter-vehicle communication system further includes a display screen, a processor, and a storage device storing instructions executable by the processor. The instructions stored in the storage device may be executable by the processor to in a first mode, generate and transmit an alert via the transceiver in response to detecting an alert condition, and in a second mode, display a received alert to a vehicle user via the display screen in response to receiving the received alert via the transceiver.

Embodiments are also disclosed for an example communications system for an on-road vehicle. The communications system may include a transceiver capable of wirelessly sending and receiving data packets encoding an alert, a display screen, a user interface for receiving inputs from a vehicle user, a processor, and a storage device storing instructions which may executable by the processor. The instructions stored in the storage device may be executed by the processor responsive to detecting an alert condition to generate an alert, and transmit the generated alert a threshold distance via the transceiver. Further the instructions may be executed by the processor responsive to receiving an alert to determine a location from which the received alert was transmitted, display the received alert to the vehicle user via the display screen, and display a route providing directions to the location from which the received alert was transmitted in response to input from the vehicle user authorizing a provision of assistance.

Methods for a vehicle communications system are also disclosed. An example method includes broadcasting an alert to within a smaller first threshold distance of a first vehicle in response to detecting alert conditions at the first vehicle, and responsive to receipt of the alert at a second vehicle, generating a route providing directions to the first vehicle, and displaying the route to one or more users of the second vehicle.

### BRIEF DESCRIPTION OF THE DRAWINGS

The disclosure may be better understood from reading the following description of non-limiting embodiments, with reference to the attached drawings, wherein below:

FIG. 1 shows a schematic depicting an example inter-vehicle communications system in accordance with one or more embodiments of the present disclosure.

FIG. 2 shows an example partial view of a vehicle cabin in accordance with one or more embodiments of the present disclosure;

FIG. 3 shows an example in-vehicle computing system in accordance with one or more embodiments of the present disclosure;

FIG. 4A shows a flow chart of an example method for transmitting an alert between vehicles in the same or similar geographic area.

FIG. 4B shows a flow chart of an example method for broadcasting an alert to vehicles in the same or similar geographic area.

FIG. 5 shows a flow chart of an example method for guiding an assisting vehicle to a vehicle in need of assistance.

### DETAILED DESCRIPTION

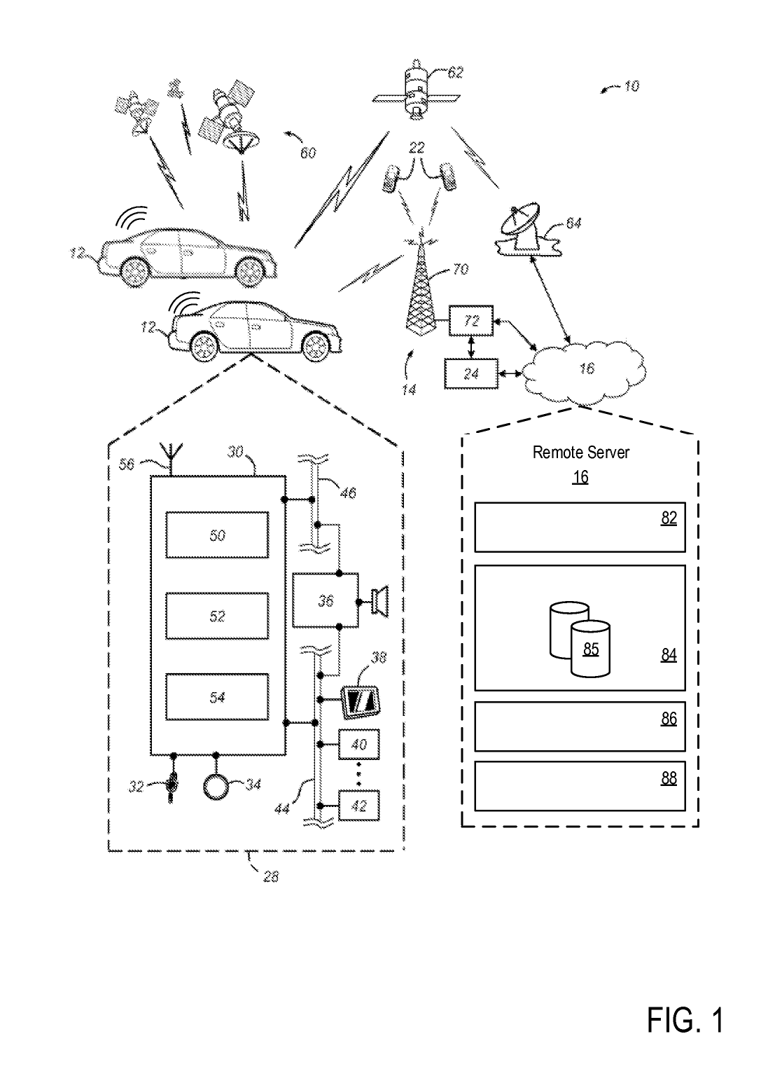

As described above, on-road emergency assistance systems are used to provide assistance to vehicles in the event of an impact or accident. The present disclosure describes an on-road assistance system that establishes communication between vehicles in the same or similar geographic area. FIG. 1, shows one such example of an assistance system capable of providing communication between multiple vehicles in the same or similar geographic region. The vehicles may transmit alerts to one another notifying of upcoming road hazards, inclement weather, construction, etc. Further, in the event of one or more of an impact, accident, mechanical failure, electrical failure, and/or medical emergency, an assistance request may be broadcast to nearby vehicles. If an operator of a nearby vehicle receiving the assistance request wishes to assist the vehicle from which the assistance request was received, then a route may be presented to the operator, guiding the operator to the location of the vehicle requesting assistance.

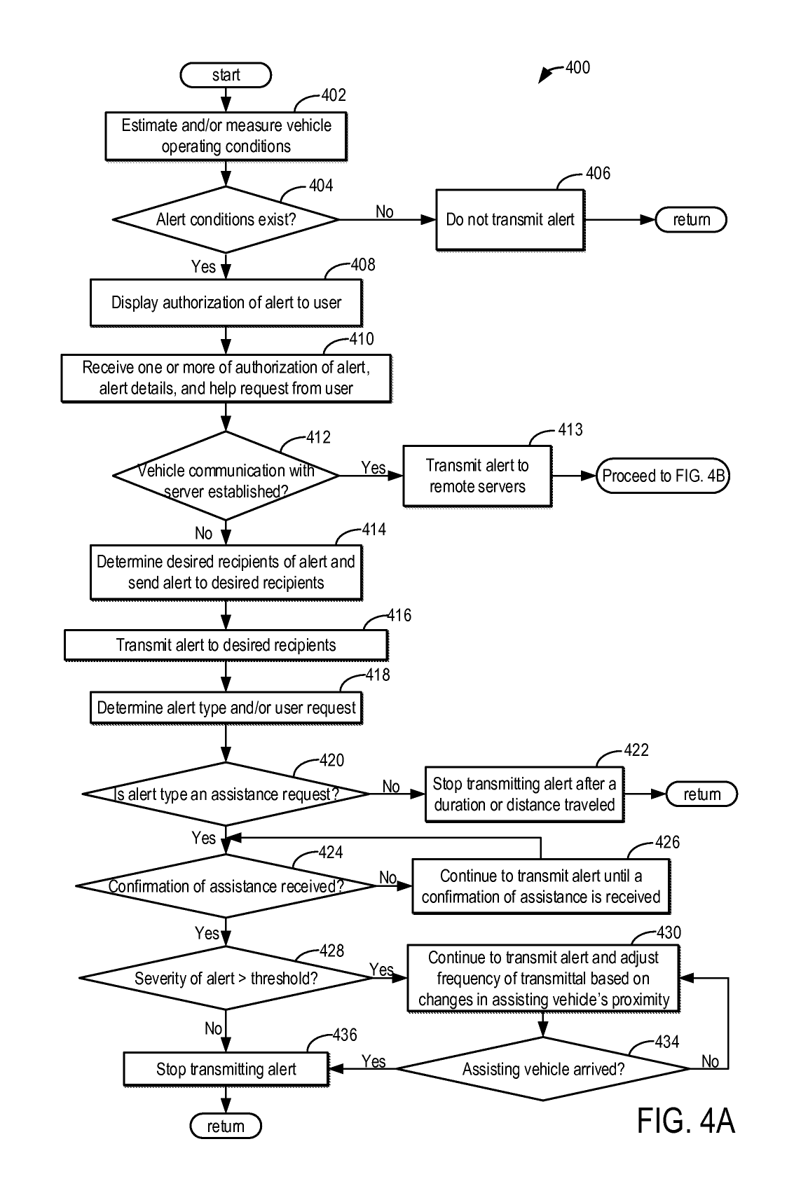

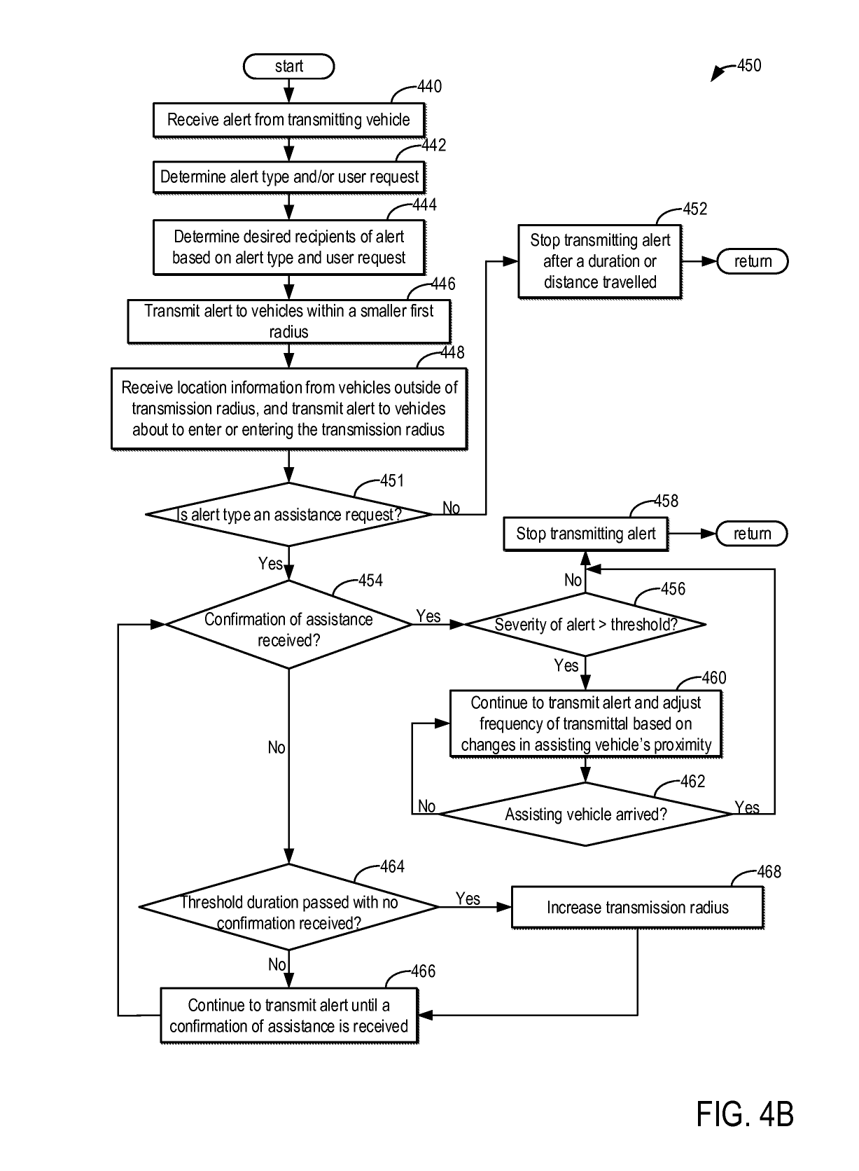

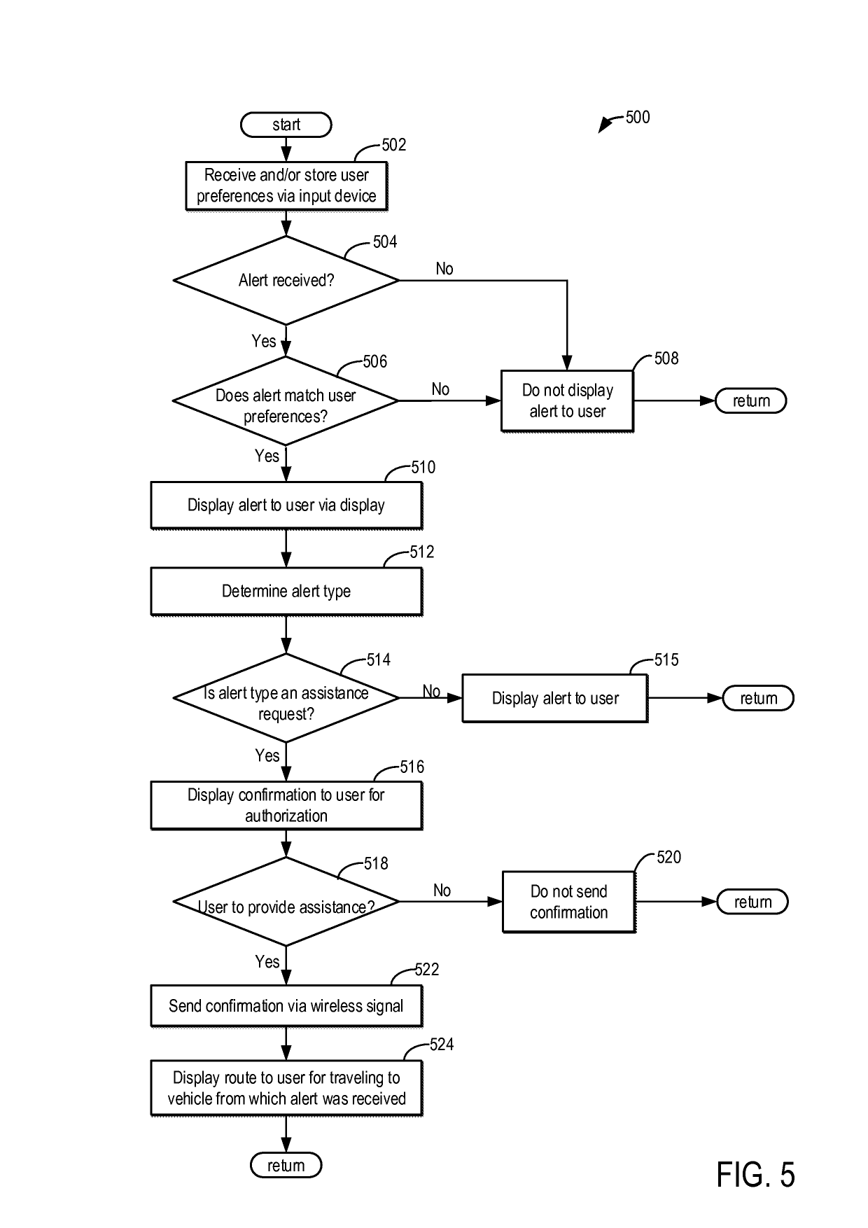

With reference to FIG. 1, there is shown an exemplary operating environment that comprises an inter-vehicle communications system 10 that can be used to implement the methods disclosed herein. Inter-vehicle communications system 10 generally includes one or more telematics-equipped vehicles 12, one or more wireless carrier systems 14, and one or more remote servers 16. In some examples, the inter-vehicle communications system 10 may additionally include various personal wireless devices 22, and a short message service center (SMSC) 24. It should be understood that the method disclosed below with reference to FIGS. 4A-5, can be used with any number of different systems and is not specifically limited to the operating environment shown here. Thus, the following paragraphs simply provide a brief overview of one possible configuration for providing wireless communication between each of the vehicles 12, and between the vehicles 12 and remote servers 16. However, it should be appreciated that other systems not shown here could be employed to execute the disclosed methods as well.

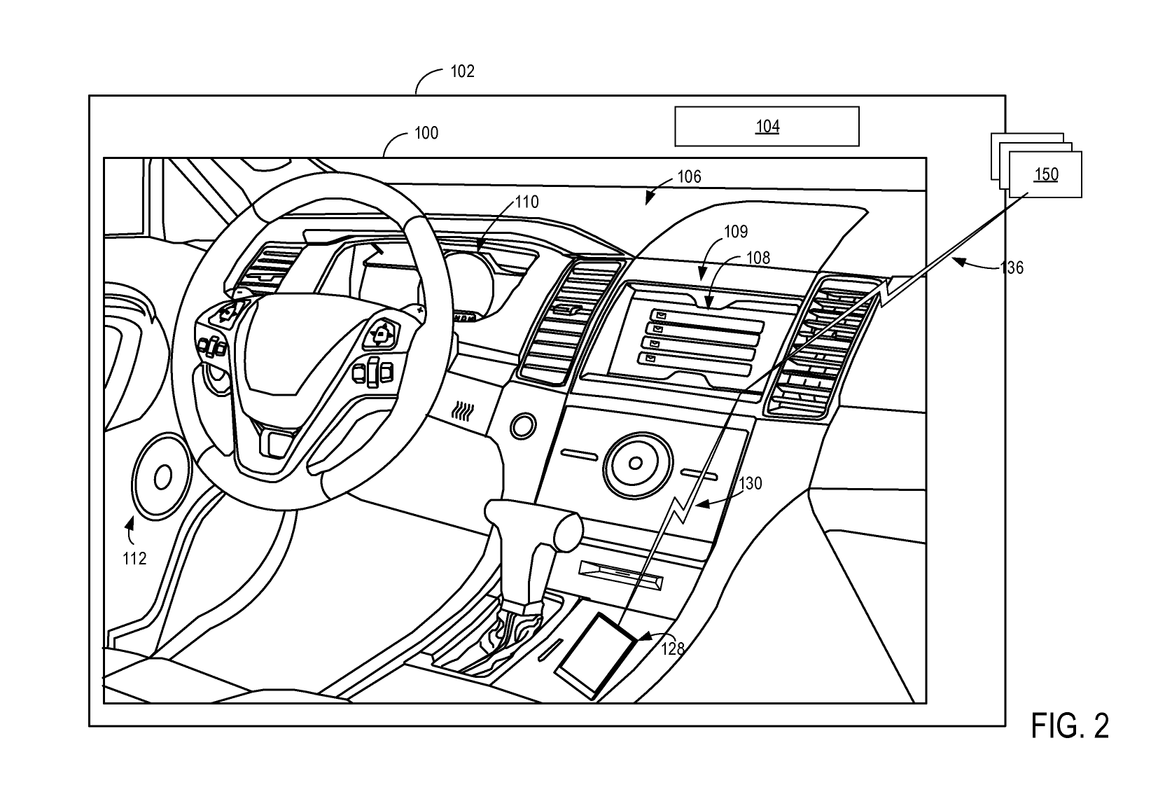

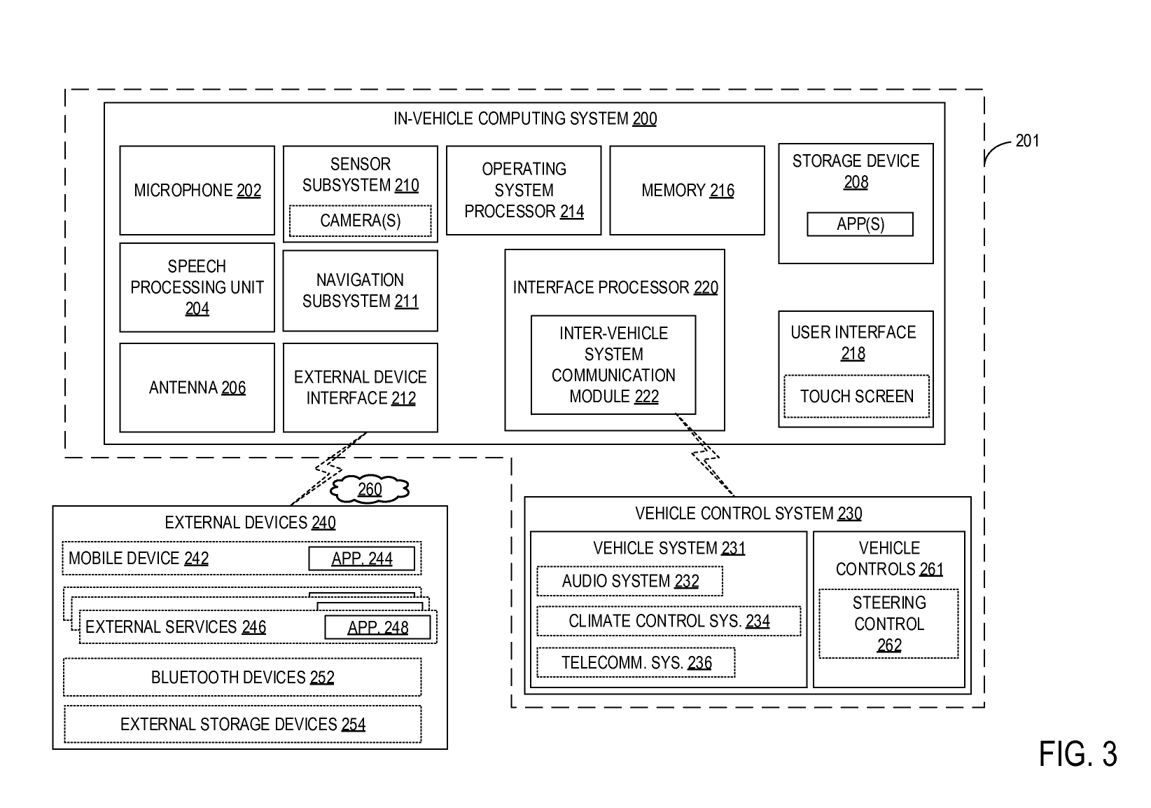

Vehicles 12 are depicted in the illustrated embodiment as passenger cars, but it should be appreciated that any other vehicle including motorcycles, trucks, sports utility vehicles (SUVs), recreational vehicles (RVs), marine vessels, aircraft, etc., can also be used. Some of the vehicle electronics 28 are shown generally in FIG. 1. More detailed depictions of example vehicle electronics which may be included in vehicles 12 are shown below with reference to FIGS. 2-3. The vehicle electronics 28 may include one or more of a telematics unit 30, a microphone 32, one or more pushbuttons or other control inputs 34, an audio system 36, a visual display 38, and a navigation module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed or aftermarket device that enables vehicles 12 to receive and/or transmit wireless signals corresponding to voice, text, and/or other data. Thus, telematics unit 30 may send and/or receive wireless signals (e.g., electromagnetic waves) such as Wifi, Bluetooth, radio, cellular, etc. Telematics unit 30 may therefore be referred to as transceiver 30, since it may be capable of both sending and receiving wireless signals. Wireless signals produced by the telematics unit 30 of vehicles 12 may be sent to and received by one or more of the vehicles 12 and remote servers 16. Thus, each of the vehicles 12 may be in wireless communication with one another for sending and/or receiving information there-between via the telematics unit 30. Further, each of the vehicles 12 may be in wireless communication with the remote servers 16 for sending and/or receiving information there-between.

In some examples, where one of the vehicles 12 is in need of assistance (e.g., impact, accident, mechanical/electrical failure, medical emergency, etc.) an assistance request may be wirelessly broadcast to other vehicles within the vicinity of the vehicle in need of assistance. If wireless communication between the vehicle in need of assistance and the remote servers 16 is disrupted, then the vehicle in need of assistance may broadcast an assistance request via the telematics unit 30. However, in other examples, where wireless communication is established between the vehicle in need of assistance and the remote server 16, the vehicle in need of assistance may send an assistance request to the remote servers 16, and the remote servers 16 may then perform a method, such as the method described below with reference to FIG. 4B, to determine the desired recipients of the assistance request. The remote servers 16 may then send an assistance request to one or more of the vehicles 12 within a threshold distance of the vehicle in need of assistance and/or may notify one or more of medical services (e.g., ambulances), tow services, public safety services, etc., depending on the type of emergency of the vehicle in need of assistance.

Wireless communication between the remote servers 16 and the vehicles 12 may be maintained even at greater distances between the servers 16 and the vehicles 12 by including relay towers 70. Each of the towers 70 may include sending and receiving antennas for relaying wireless signals between the remote servers 16 and the vehicles 12.

However, it should be appreciated that in some examples, relay towers 70 may not be included in the communications system 10, and that the vehicles 12 may be in direct wireless communication with the remote servers 16. Further, if one or more of the vehicles 12 are separated from the remote server 16 by a sufficient distance, and/or terrain (e.g., mountains) blocks the wireless signal from being transmitted there-between, then the one or more vehicles 12 may not be in wireless communication with the servers 16.

Additionally or alternatively, communications system 10 may utilize satellite communications to provide uni-directional or bi-directional communication between one or more of the vehicles 12 and the remote servers 16. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Further, in some examples as shown below with reference to FIGS. 4A-5, each of the vehicles 12 may wirelessly transmit information to the satellite 62, which broadcasts the information to the servers 16.

As such, each of the vehicles 12 may communicate with one or more of remote server 16, other telematics-equipped vehicles 12, or some other entity or device capable of transmitting and/or receiving wireless signals. Telematics unit 30 enables the vehicle to offer a number of different services including those related to messaging, navigation, telephony, emergency assistance, diagnostics, infotainment, etc. Data can be sent over a data connection, such as via a packet switching connection, or via a voice channel using techniques already known in the art. For combined services that involve both voice communication and data communication, the system can utilize a single call over a voice channel and switch as needed between voice and data transmission over the voice channel, and this can be done using techniques known to those skilled in the art.

According to one embodiment, telematics unit 30 utilizes a wireless modem 50 for data transmission, an electronic processing device 52, one or more digital memory devices 54, and a dual antenna 56. It should be appreciated that the modem can either be implemented through software or it can be a separate hardware component located internal or external to telematics unit 30. The modem can operate using any number of different standards or protocols such as EVDO, CDMA, GPRS, and EDGE. Wireless networking between the vehicles 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet switching data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit 30 to provide a wide variety of services. For instance, processor 52 can execute programs or process data to carry out at least a part of the methods discussed herein.

Telematics unit 30 can be used to provide a diverse range of vehicle services that involve wireless communication to and from the vehicles 12. Such services can include: remote control of certain vehicle features through the use of VSMs 42; turn-by-turn directions and other navigation-related services provided in conjunction with the navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the exemplary telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicles 12, to cite but a few possibilities. In the event that the modules are implemented as VSMs 42 located external to telematics unit 30, they could utilize communications bus 44 to exchange data and commands with the telematics unit 30.

Navigation module 40 may be configured to support any suitable navigation system such as GPS, GALILEO, GLONASS, IRNSS, etc. In examples, where the navigation module 40 is a GPS navigation module, the module 40 receives signals from a constellation of GPS satellites 60. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of navigation module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote servers 16, for other purposes, such as fleet management.

Apart from the audio system 36 and navigation module 40, the vehicles 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests and perform other functions. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks. According to one embodiment, the ECM is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicles 12, as numerous others are also possible.

Vehicle electronics 28 may also include a number of vehicle user interfaces that provide vehicle occupants with a means of providing and/or receiving information, such as microphone 32, pushbuttons(s) 34, audio system 36, and visual display 38. As used herein, the term ‘vehicle user interface’ broadly includes any suitable form of electronic device, including both hardware and software components, which is located on the vehicles 12 and enables a vehicle user to communicate with or through a component of the vehicles 12. In the description herein a vehicle user may also be referred to simply as a user, and/or a vehicle operator. Microphone 32 provides audio input to the telematics unit 30 to enable the driver or other occupant to provide voice commands and carry out hands-free calling. For this purpose, it can be connected to an on-board automated voice processing unit utilizing human-machine interface (HMI) technology known in the art. The pushbutton(s) 34 allow manual user input into the telematics unit 30 to provide data, response, or control input. Separate pushbuttons can be used for initiating emergency calls versus regular service assistance calls. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel, a pop-up visual display, or a heads-up display reflected off of the windshield, and can be used to provide a multitude of input and output functions. Various other vehicle user interfaces can also be utilized, as the interfaces of FIG. 1 are only an example of one particular implementation.

Remote servers 16 may be a computing device configured to: generate a user personalized grade for a medication, and calculate medication costs from claims data. In one example, the user personalized grade may be related to the predicted effectiveness of the medication. Further the user personalized grade may be based on one or more of available scientific research, clinical studies, patient reviews, care provider recommendations, etc. In different embodiments, remote servers 16 may take the form of a mainframe computer, server computer, desktop computer, laptop computer, tablet computer, home entertainment computer, network computing device, mobile computing device, mobile communication device, gaming device, etc.

Remote servers 16 may include a logic subsystem 82 and a data-holding subsystem 84. Remote servers 16 may optionally include a display subsystem 86, communication subsystem 88, and/or other components not shown in FIG. 2. For example, remote servers 16 may also optionally include user input devices such as keyboards, mice, game controllers, cameras, microphones, and/or touch screens.

Logic subsystem 82 may include one or more physical devices configured to execute one or more instructions. For example, logic subsystem 82 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 82 may include one or more processors that are configured to execute software instructions. Additionally or alternatively, the logic subsystem 82 may include one or more hardware or firmware logic machines configured to execute hardware or firmware instructions. Processors of the logic subsystem 82 may be single or multi-core, and the programs executed thereon may be configured for parallel or distributed processing. The logic subsystem 82 may optionally include individual components that are distributed throughout two or more devices, which may be remotely located and/or configured for coordinated processing. For example, the logic subsystem 82 may include several engines for processing and analyzing data. These engines may be wirelessly connected to one or more databases for processing data received from one or more of the vehicles 12. One or more aspects of the logic subsystem 82 may be virtualized and executed by remotely accessible networked computing devices configured in a cloud computing configuration.

Data-holding subsystem 84 may include one or more physical, non-transitory devices configured to hold data and/or instructions executable by the logic subsystem 82 to implement the herein described methods and processes. When such methods and processes are implemented, the state of data-holding subsystem 84 may be transformed (for example, to hold different data).

Data-holding subsystem 84 may include removable media and/or built-in devices. Data-holding subsystem 84 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 84 may include devices with one or more of the following characteristics: volatile, nonvolatile, dynamic, static, read/write, read-only, random access, sequential access, location addressable, file addressable, and content addressable. In some embodiments, logic subsystem 82 and data-holding subsystem 84 may be integrated into one or more common devices, such as an application-specific integrated circuit or a system on a chip.

It is to be appreciated that data-holding subsystem 84 includes one or more physical, non-transitory devices. In contrast, in some embodiments aspects of the instructions described herein may be propagated in a transitory fashion by a pure signal (for example, an electromagnetic signal) that is not held by a physical device for at least a finite duration. Furthermore, data and/or other forms of information pertaining to the present disclosure may be propagated by a pure signal.

Servers 16 may include one or more databases 85 in data-holding subsystem 84 for storing processed requests for assistance, vehicle location data, and vehicle operator preferences.

When included, display subsystem 86 may be used to present a visual representation of data held by data-holding subsystem 84. As the herein described methods and processes change the data held by the data-holding subsystem 84, and thus transform the state of the data-holding subsystem 84, the state of display subsystem 86 may likewise be transformed to visually represent changes in the underlying data. Display subsystem 86 may include one or more display devices utilizing virtually any type of technology. Such display devices may be combined with logic subsystem 82 and/or data-holding subsystem 84 in a shared enclosure, or such display devices may be peripheral display devices.

When included, communication subsystem 88 may be configured to communicatively couple remote servers 16 with one or more other computing devices, such as vehicles 12. Communication subsystem 88 may include wired and/or wireless communication devices compatible with one or more different communication protocols. As non-limiting examples, communication subsystem 88 may be configured for communication via a wireless telephone network, a wireless local area network, a wired local area network, a wireless wide area network, a wired wide area network, etc. In some embodiments, communication subsystem 88 may allow remote servers 16 to send and/or receive messages to and/or from other devices via a network such as the public Internet.

In some examples, the relay towers 70 may be configured as part of a wireless cellular network. In such examples, the communications system 10 may include personal wireless devices 22 which can be, for example, cellular phones or other personal portable devices capable of wireless communication including, for the illustrated embodiment, SMS messaging capability. The devices 22 can communicate with the relay towers 70 to send and receive voice calls, SMS messages, and possibly other communications such as non-speech data for purposes of providing Internet access, weather information, stock information, etc. Further, the telematics unit 30 of each of the vehicles 12 may be capable of sending and/or receiving SMS messages, and phone calls via the cellular network provided by the relay towers 70.

As such, telematics unit 30 may utilize cellular communication according to either GSM or CDMA standards and thus may include a standard cellular chipset for voice communications like hands-free calling.

Further, communications system may include one or more mobile switching centers (MSCs) 72, as well as any other networking components required to connect wireless carrier system 14 with remote servers 16. Each of the relay towers 70 may therefore include sending and receiving antennas and a base station, with the base stations from different cell towers being connected to the MSC 72 either directly or via intermediary equipment such as a base station controller. Wireless carrier system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Short message service center (SMSC) 24 is preferably in communication with relay towers 70 and is involved in the communication of SMS messages. SMSC 24 can operate according to a store-and-forward principal; that is, when a first user sends an SMS message that is intended for a second user, the SMS message gets stored at the SMSC until the second user is available to receive it. In other embodiments, the SMSC employs a store-and-forget approach where it only attempts to pass the SMS message along one time. These types of approaches enable users to send and receive SMS messages at any time, even if they are currently on a voice call. It should of course be appreciated that the exemplary representation of SMSC 24 is but one example of a suitable arrangement, as the SMSC could instead be provided according to some other configuration known in the art. In general, SMS messages sent to or from the vehicles 12 or wireless mobile devices 22 are received and/or transmitted by the relay towers 70, and pass through the MSC 72 and SMSC 24 for processing and routing to the remote servers 16.

An example interior of a cabin of one of the vehicles 12 is shown below with reference to FIG. 2.

FIG. 2 shows an example partial view of one type of environment for a communication system for data synchronization: an interior of a cabin 100 of a vehicle 102, in which a driver and/or one or more passengers may be seated. Vehicle 102 may be the same or similar to vehicles 12 described above with reference to FIG. 1. Vehicle 102 of FIG. 2 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a driver (also referred to as the user) of vehicle 102. For example, instrument panel 106 may include a touch screen 108 of an in-vehicle computing system 109 (e.g., an infotainment system), an audio system control panel, and an instrument cluster 110. While the example system shown in FIG. 2 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128.

In some embodiments, one or more hardware elements of in-vehicle computing system 109, such as touch screen 108, a display screen, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system may be modular and may be installed in multiple locations of the vehicle.

The cabin 100 may include one or more sensors for monitoring the vehicle, the user, and/or the environment. For example, the cabin 100 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 100, etc. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as sensors coupled to external devices 150 and/or mobile device 128.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, navigation system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108.

In-vehicle computing system 109 may analyze the input received from external devices 150, mobile device 128, and/or other input sources and select settings for various in-vehicle systems (such as climate control system or audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

FIG. 3 shows a block diagram of an in-vehicle computing system 200 configured and/or integrated inside vehicle 201. In-vehicle computing system 200 may be an example of in-vehicle computing system 109 of FIG. 2 and/or may perform one or more of the methods described herein in some embodiments. In some examples, the in-vehicle computing system may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 201 in order to enhance an in-vehicle experience for a driver and/or a passenger.

The in-vehicle computing system 200 may be configured to detect the occurrence of an accident, impact, or mechanical failure of the vehicle 201 based on input received from the various sensors of vehicle 201. Further, in some examples, a vehicle user, may be able to signal that an impact, accident, mechanical failure, etc., has occurred via user inputs such as buttons, touch screen, etc., of user interface 218.

In-vehicle computing system 200 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network [CAN] bus through which engine related information may be communicated, a climate control CAN bus through which climate control related information may be communicated, and a multimedia data network through which multimedia data is communicated between multimedia components in the vehicle). For example, the in-vehicle computing system may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 200 to store data such as instructions executable by processors 214 and 220 in non-volatile form. The storage device 208 may store application data to enable the in-vehicle computing system 200 to run an application for connecting to a cloud-based server and/or collecting information for transmission to the cloud-based server (e.g., remote servers 16 shown in FIG. 1). The application may retrieve information gathered by vehicle systems/sensors, input devices (e.g., user interface 218), devices in communication with the in-vehicle computing system (e.g., a mobile device connected via a Bluetooth link), etc. In-vehicle computing system 200 may further include a volatile memory 216. Volatile memory 216 may be random access memory (RAM). Non-transitory storage devices, such as non-volatile storage device 208 and/or volatile memory 216, may store instructions and/or code that, when executed by a processor (e.g., operating system processor 214 and/or interface processor 220), controls the in-vehicle computing system 200 to perform one or more of the actions described in the disclosure.

A microphone 202 may be included in the in-vehicle computing system 200 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 200 may also be able to receive voice commands and sample ambient vehicle noise using a microphone included in an audio system 232 of the vehicle.

One or more additional sensors may be included in a sensor subsystem 210 of the in-vehicle computing system 200. For example, the sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system 200 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 200 may generate and/or receive navigation information such as location information (e.g., via a GPS sensor and/or other sensors from sensor subsystem 210), route guidance, traffic information, point-of-interest (POI) identification, and/or provide other navigational services for the driver.

External device interface 212 of in-vehicle computing system 200 may be coupleable to and/or communicate with one or more external devices 240 located external to vehicle 201. While the external devices are illustrated as being located external to vehicle 201, it is to be understood that they may be temporarily housed in vehicle 201, such as when the user is operating the external devices while operating vehicle 201. In other words, the external devices 240 are not integral to vehicle 201.

The external devices 240 may include a mobile device 242 (e.g., connected via a Bluetooth, NFC, WIFI direct, or other wireless connection) or an alternate Bluetooth-enabled device 252. Mobile device 242 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. For example, the external storage devices 254 may include servers 16 described above with reference to FIG. 1.

As such, external storage devices 254 may receive requests for assistance from the in-vehicle computing system 200. Operating system processor 214 may determine whether an impact, accident, mechanical and/or electrical failure, occupant medical emergency, of other type of emergency has occurred based on outputs received from the vehicle sensors. Additionally or alternatively, a vehicle driver or passenger may communicate a need for assistance to the operating system processor 214 via the user interface 218. In response to a determination that an impact, accident, mechanical failure, or other emergency has occurred the operating system processor 214 may transmit a request for assistance to the external storage devices 254.

The external storage devices 254 may process the request and determine the desired recipients of the assistance request. In some embodiments, the storage devices 254 may transmit the assistance request to vehicle located in the same geographic area, or within a threshold distance of the vehicle from which the assistance request was received so that nearby vehicles may assist the vehicle. Further, the storage devices 254 may contact external services 246 such as ambulances, tow trucks, police, etc., to provide the desired assistance to the vehicle.

External devices 240 may communicate with in-vehicle computing system 200 either wirelessly or via connectors without departing from the scope of this disclosure. For example, external devices 240 may communicate with in-vehicle computing system 200 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct, as described in more detail below.

One or more applications 244 may be operable on mobile device 242. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 242 from in-vehicle computing system 200 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, etc.) or other applications (e.g., navigational applications) of mobile device 242 to enable the requested data to be collected on the mobile device. Mobile device application 244 may then relay the collected information back to in-vehicle computing system 200.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers. Vehicle audio system 232 may be passive or active such as by including a power amplifier. In some examples, in-vehicle computing system 200 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 201. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 200, such as via communication module 222. The control elements of the vehicle control system may be physically and permanently positioned on and/or in the vehicle for receiving user input. In addition to receiving control instructions from in-vehicle computing system 200, vehicle control system 230 may also receive input from one or more external devices 240 operated by the user, such as from mobile device 242. This allows aspects of vehicle systems 231 and vehicle controls 261 to be controlled based on user input received from the external devices 240.

In-vehicle computing system 200 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via RF such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 240 (such as to mobile device 242) via external device interface 212.

One or more elements of the in-vehicle computing system 200 may be controlled by a user via user interface 218. User interface 218 may include a graphical user interface presented on a touch screen, such as touch screen 108 of FIG. 2, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 200 and mobile device 242 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

Turning now to FIGS. 4A-5, they show flow charts of example methods, for broadcasting messages, alerts, notifications, etc., from a vehicle (e.g., vehicles 12 shown in FIG. 1) to other vehicles within the same or similar geographic area. As such, the flow charts shown in FIGS. 4A-5 may provide example methods which may be executed to increase inter-vehicle communication between vehicles in the same or similar geographic area. As such, FIGS. 4A-5 may be described together in the description herein. The flow chart in FIG. 4A shows an example method for broadcasting messages when a vehicle is not in wireless communication with one or more remote servers (e.g., servers 16 shown in FIG. 1). FIG. 4B shows an example method for broadcasting messages when the vehicle is in wireless communication with the remote servers. The flow chart in FIG. 5 shows an example method for displaying messages, alerts, notifications, etc., to a vehicle user. The messages, alerts, notifications, etc., may be encoded and transmitted wirelessly in packets of data. Thus, wireless signals including packets of data corresponding to alerts, messages, notifications, etc., may be transmitted via any known transmitter capable of sending electromagnetic waves such as Wifi, Bluetooth, radio, etc.

Any one or a combination of the above example methods may be used to broadcast a notification regarding weather, traffic/road conditions, hazards, etc. Thus, upon encountering a hazard, road work, inclement weather, etc., a vehicle may broadcast this information to other vehicles in the surrounding area, and/or to vehicles that may enter the same geographic area. In this way, vehicles may be provided with details of upcoming road, weather, traffic, or other conditions.

The above example methods may also be used to broadcast an assistance request from a vehicle. An assistance request may be a message, alert, or other form of notification that may include text, voice, audio, video, or other form of digital information that may notify other vehicles of a vehicle in need of their assistance. For example, an assistance request may be broadcast in response to an impact, accident, mechanical failure, electrical failure, or medical emergency of an operator or passenger of a vehicle. The assistance request may include the geographical coordinates or location of the vehicle broadcasting the assistance request, so that nearby vehicles may assist the vehicle. Further, the assistance request may include details regarding the reason for the request, type of request, time, importance, severity, etc. In some examples, services such as ambulances, tow trucks, police, etc., may be notified of the location of the vehicle requesting assistance, so that they may provide assistance.

Focusing now on FIG. 4A, it shows an example method 400 for broadcasting messages when the vehicle is not in wireless communication with the one or more remote servers. Instructions for carrying out method 400 may be stored in non-transitory memory of a vehicle controller (e.g., operating system processor 214 shown in FIG. 3). As such, method 400 may be executed by the controller based on the stored instructions and in conjunction with signals received from sensors of the vehicle system such as the sensors described above with reference to FIGS. 2-3. The controller may employ a communication system (e.g., external device interface 212 shown in FIG. 3, or telematics unit 30 shown in FIG. 1) to transmit a wireless signal to other vehicles in the same or similar geographic area.

Method 400 begins at 402 which comprises estimating and/or measuring vehicle operating conditions. Vehicle operating conditions may include ambient temperature, humidity, precipitation, road surface conditions, proximity to external objects, deformation of the body of the vehicle in instances of an impact, engine speed, vehicle electrical and mechanical conditions, and vehicle brake conditions, air bag deployment, vehicle occupant medical conditions, vehicle acceleration, impact force, etc.

After estimating and/or measuring vehicle operating conditions at 402, method 400 may continue to 404 which comprises determining if alert conditions exist. Alert conditions may be determined by the controller based on outputs received from various sensors of the vehicle. For example, alert conditions may include vehicle impacts, accidents, mechanical and/or electrical failures, etc. Vehicle impacts may be detected based on an amount of deformation of the body of the vehicle as estimated from various electronic acceleration sensors. However, in other examples, alert conditions may include road and/or traffic conditions such as road construction, inclement weather, environmental conditions, attempt of theft/vandalism, riots etc. A vehicle operator may generate an alert via inputs on a user interface (e.g., user interface 218 shown in FIG. 3) which may include various buttons (e.g., pushbuttons 34 shown in FIG. 1), touch screen (e.g., touch screen 108 shown in FIG. 2), or other input device.

If alert conditions do not exist, then method 400 continues to 406, and an alert is not transmitted. Thus, the method 400 at 406 may comprise not sending an alert via the communication system. Method 400 then returns.

However, if it is determined at 404 that alert conditions exist, then method 400 may continue from 404 to 412 which comprises determining if vehicle communication with the remote servers is established prior to transmitting the alert at 416. In some examples, however, if the alert conditions detected at 404 are initiated by inputs from the vehicle operator, then method 400 may proceed from 404 to optional steps 408 and 410 which comprise displaying an authorization to the vehicle operator and receiving authorization from the vehicle operator, before continuing to 412. Thus, if alert conditions are detected via inputs from the vehicle operator at 404, then the method 400 may proceed from 404 to 406 which comprises displaying an authorization to one or more vehicle occupants, and then to 408, which comprises receiving authorization from one or more vehicle occupants before transmitting the alert.

Additionally or alternatively, as described below with reference to FIG. 5, preferences of one or more of the vehicle occupants may be stored in non-transitory memory of the controller which provide conditions under which authorization from the vehicle operator is required before sending an alert. Said another way, a vehicle occupant may input pre-set conditions under which authorization from the one or more vehicle occupants is required before the alert may be transmitted. Thus, if the alert conditions detected at 404 match with the stored pre-set conditions of the one or more vehicle occupants, then method 400 may continue from 404 to 406 and display an authorization to the one or more vehicle occupants.

As an example, a vehicle occupant may input preferences that require their authorization before transmitting an alert under conditions where one or more of a vehicle impact is less than a threshold, there is mechanical and/or electrical failure, the alert is related to inclement weather and/or road conditions, etc. Put more simply, an authorization from a vehicle occupant may be required before sending the alert, if it is determined that one or more of the vehicle occupants are capable of authorizing the alert. Thus, the location of the vehicle may not be transmitted to other vehicles without authorization from one or more of the vehicle occupants, if the alert was initiated by one of the vehicle occupants and/or the alert conditions under which the alert was initiated match to pre-set conditions stored in the preferences of one or more of the vehicle occupants.

If authorization from a vehicle occupant is required before transmitting the alert, method 400 may therefore proceed from 404 to 406, which comprises displaying an authorization of the alert to one or more of the vehicle occupants. For example, the authorization may be displayed to a vehicle occupant via a display screen (e.g., touch screen 108 shown in FIG. 2). The authorization may be presented to the vehicle occupant before the alert is transmitted. Thus, an alert may not be transmitted without consent from a vehicle occupant if the alert was initiated by the vehicle occupant and/or the alert conditions determined at 404 match the pre-set conditions stored in the user preferences of the one or more of the vehicle occupants. The authorization may provide a vehicle occupant with a message such as “PROCEED TO TRANSMIT MESSAGE?” which may query the vehicle occupant as to whether or not it is acceptable to continue with transmitting the alert.

In response to the display of the authorization at 408, one or more of the vehicle occupants, may give their consent to transmit the alert. Thus, method 400 may continue from 408 to 410 which comprises receiving one or more of the authorization of the alert from a vehicle occupant, alert details, and assistance request from a vehicle occupant. In addition to authorizing the alert at 410, therefore, a vehicle occupant may also provide any additional details they wish to include in the alert, such as the type of alert, type of emergency, importance, desired assistance, severity, contact information such as mobile number, vehicle category/make etc.

Further, profile information, such as information about one or more of the vehicle occupants and/or information about the vehicle may be stored in non-transitory memory of the controller and may be included in the alert. As described below with reference to FIG. 5, a vehicle occupant may store their profile information in the non-transitory memory of the controller via input devices such as the display screen, buttons, etc. The profile information may include one or more of the name, age, gender, medical conditions, etc., of the vehicle occupant. Further, the profile information may include one or more of the make, model, year, etc., of the vehicle. Thus, the alert may include any or all of the profile information of the vehicle occupant and/or of the transmitting vehicle.

The method 400 may then continue from either 410, or directly from 404 to 412 which may include determining if vehicle communication with the remote servers is established. Thus, method 400 may proceed directly from 404 to 412, and may not require authorization from a vehicle occupant before transmitting the alert, if the alert was not initiated by a vehicle occupant and the alert conditions do not match the pre-set conditions stored in the user preferences. For example, if the impact of the crash is detected to be greater than a threshold, authorization from a vehicle occupant may not be required before transmitting the alert. In another example, if one of the vehicle occupants is in need of emergency medical assistance, authorization from a vehicle occupant may not be required before transmitting the alert. In this way, if conditions exist where one or more of the vehicle occupants may be unable to authorize transmission of the alert, the alert may automatically be transmitted in response

Determining if the vehicle is in wireless communication with the remote servers may be determined based on signals received from the remote servers. Thus, if the distance between the vehicle and the remote servers is sufficiently far, or geographic features such as mountain, trees, etc., block the wireless signal between the vehicle and the server, then wireless signals produced by the vehicle may not be received by the remote servers, and vice versa. Thus, if wireless communication with the remote servers is currently available for the vehicle, then method 400 may proceed to 413 from 412, which comprises transmitting the alert to the remote servers. In some examples, the alert may be transmitted via preferred electromagnetic wave frequency and/or intensity directly from the vehicle to the remote servers. However, in other examples, one or more relay towers (e.g., relay towers 70 shown in FIG. 1) may propagate the alert from the vehicle to the remote servers. After transmitting the alert to the remote servers, the remote servers may execute a method, such as the method 450 of FIG. 4B. Thus, method 400 may proceed to method 450 described below in FIG. 4B from 413. As such, method 450 shown in FIG. 4B, may be executed when the vehicle is in wireless communication with the remote servers.

However, if it is determined at 412 that the vehicle is not in wireless communication with the remote servers (e.g., wireless signal from the remote servers has not been received for more than a threshold duration), then method 400 may continue to 414 which comprises determining the desired recipients of the alert and sending the alert to the desired recipients.

The desired recipients may be based on user preferences and the alert details provided by the user at 410. An example method for receiving and storing user preferences is shown below with reference to FIG. 5. In some examples, the desired recipients may be all vehicles within the range of the wireless transmission of the communications system. The range of the communications system may in some examples be approximately 1 km. However, in other examples, it may 2 km. In still further examples, the strength of the wireless transmission may be capable of extending to anywhere from 0.5 km, to 4 km. Thus, all vehicles equipped with a communications system capable of receiving wireless signals (e.g., electromagnetic waves), and in the transmission range of the communications system may receive the alert.

However, in other examples, the alert may only be sent to a subset of vehicles within the transmission range of the communications system. In still further examples, the desired recipients may include medical services, tow services, mechanics, taxi services, etc., in addition to vehicles within the transmission range of the communications system. For example, if a mechanical failure occurs, then the alert may be transmitted to a car repair shop or mechanic. In the event of a medical emergency of one of the passengers and/or driver of the vehicle, an alert may be sent to an ambulance. Thus depending on the nature of the alert, one or more third party services may be notified of the alert of the vehicle.

After determining the desired recipients at 414, method 400 may continue to 416 which comprises generating and transmitting the alert to the desired recipients. Thus, the communications system including a transceiver (e.g., transceiver 30 shown in FIG. 1) may broadcast the alert at 416. Wireless signals (e.g., radio waves, Wifi, Bluetooth, etc.) produced by the transceiver may propagate and be received by vehicles and/or other third parties external to the vehicle, within the transmissions range of the vehicle. In some examples, the transmission range may be varied by varying the intensity of the wireless signals.

As described above, the alert may include one or more of the alert type, severity of the alert, vehicle operator information and/or vehicle information from the vehicle transmitting the alert, location of the vehicle, etc. The location of the vehicle transmitting the alert may be determined based on outputs from a navigation module (e.g., navigation module 40 shown in FIG. 1). Thus, the geographical location of the vehicle may be transmitted in the alert. Further, in examples, where the alert type is not a request for assistance, the alert may include one or more of road conditions, inclement weather, traffic updates, road maintenance, etc. The method 400 at 416 may therefore comprise encoding the alert in a package of data and wirelessly transmitting/broadcasting the alert. As such, the method 400 at 416 may comprise transmitting wireless signals encoding packets of data corresponding to one or more of the alert type, severity of the alert, vehicle operator information and/or vehicle information from the vehicle transmitting the alert, location of the vehicle, vehicle operating conditions such as engine speed, vehicle speed, vehicle acceleration, impact force, vehicle body deformation, air bag deployment, etc.

Next, At 418, the controller may determine the alert type and/or user request of the alert transmitted at 416. The alert type may be a first type comprising a request for assistance. However, in other examples, the alert type may be a second type, the second type different than the first type. Thus the second type of alerts may not include requests for assistance. Instead the second type of alert may include a summary of current driving, road, weather, and/or environmental conditions at the current geographical location of the vehicle.

After determining the alert type, method 400 may continue to 420 which comprises determining if the alert type is a request for assistance. A request for assistance may be a request for a third party external to the vehicle transmitting the alert to come to the location of the vehicle transmitting the alert in the event of an impact, accident, mechanical and/or electrical failure of the vehicle, etc., and/or a medical emergency of a vehicle occupant. If the alert type is not an assistance request, then method 400 may continue from 420 to 422 which comprises stopping transmission of the alert after a threshold duration. The threshold duration may be stored in non-transitory memory of the controller. The duration may be a pre-set number of engine cycles, amount of time, a threshold distance traveled since the start of the transmission of the alert, etc.

Thus, if a vehicle encounters inclement weather, road work, road hazards, or other road/weather conditions, it may generate an alert communicating it current geographical coordinates, and the current road and/or weather conditions at its present geographical location. However, after a threshold duration from the time when the alert was first generated, or after a threshold distance has been traveled from the location at which the alert was first generated, the vehicle may stop transmitting the alert. Method 400 may then return.

However, if the alert type is an assistance request at 420, then method 400 may continue from 420 to 424 which comprises determining if confirmation of assistance has been received. An assisting vehicle, which may be a vehicle external to the vehicle requesting assistance, may confirm that they will travel to the location of the vehicle transmitting the alert and provide assistance, for example according to the method described below with reference to FIG. 5. For the purpose of clarity in the description herein, the vehicle transmitting the alert may be referred to the as the transmitting vehicle. Further, any one or more vehicles providing assistance to the transmitting vehicle may be referred to as an assisting vehicle.

If wireless signals from a source external to the transmitting vehicle have not been received by transceiver of the transmitting vehicle, then method 400 may proceed from 424 to 426 and the vehicle requesting assistance may continue to transmit the alert until a confirmation of assistance is received. The confirmation of assistance may be an electronic message in the form of voice, text, video, etc., specifying that the assisting vehicle is en route to the vehicle requesting assistance. In some examples, the confirmation of assistance may include one or more of a distance between the transmitting vehicle and the assisting vehicle and/or an arrival time of the assisting vehicle. The distance between the transmitting vehicle and the assisting vehicle and/or the arrival time of the assisting vehicle at the geographic location of the transmitting vehicle may be determined based on outputs from the navigation module.

Thus, the transceiver may continue to broadcast the alert to other vehicles within the transmissions range, until at least one of the vehicles in the transmissions range sends a wireless signal back to the transmitting vehicle, the wireless signal encoding a packet of data confirming that the at least one of the vehicles in the transmission range is en route to the geographic location of the transmitting vehicle.

After receiving confirmation that an assisting vehicle is en route, the method may continue from 424 to 428 which comprises determining if the severity of the alert is greater than a threshold. The severity of the alert may be determined based on input from one of the vehicle users, and/or from sensors of the vehicle. In examples where a vehicle crash has occurred, the severity of the alert may be based on an amount of deformation of the car, or the impact force of the crash. However, in other examples, where one of the vehicle users is in a medical emergency, the severity of the alert may be based on the medical emergency of the vehicle occupant.

If the severity of the alert is not greater than the threshold at 428, then method 400 may continue from 428 to 436 which comprises stopping transmittal of the alert. Thus, once an assisting vehicle has confirmed that they are en route to the transmitting vehicle, the transmitting vehicle may stop transmitting the alert. Method 400 may then return.

However, if the severity of the assistance request is greater than the threshold at 428, method 400 may continue from 428 to 430, which may comprise continuing to transmit the alert and adjusting the frequency of transmittal of the alert based on changes in the assisting vehicle's proximity to the transmitting vehicle. Thus, prior to receiving confirmation of assistance from an assisting vehicle, the transmitting vehicle may wirelessly send the alert at a higher first frequency. If the severity of the alert is greater than the threshold, then the transmitting vehicle may continue to wirelessly send the alert after receiving confirmation of assistance from an assisting vehicle, but at a lower second frequency. In still further examples, the frequency at which the alert is sent may be based on the distance between the transmitting vehicle and the assisting vehicle, where the frequency of the transmittal frequency of the alert may monotonically decrease for decreases in the distance between the assisting vehicle and the transmitting vehicle.

Method 400 may then continue from 430 to 434 which comprises determining if the assisting vehicle has arrived at the location of the transmitting vehicle. The assisting vehicle may transmit its geographical location to the transmitting vehicle once it has confirmed that it is providing assistance to the transmitting vehicle. As such, the transmitting vehicle may monitor the position of the assisting vehicle, and therefore its progress towards reaching the transmitting vehicle. The controller of the transmitting vehicle may determine that the assisting vehicle has arrived at the location of the transmitting vehicle, once the assisting vehicle is within a threshold distance of the transmitting vehicle. Thus, the controller may track the distance between the transmitting vehicle and the assisting vehicle based on the difference between their geographical coordinates.

If the assisting vehicle is more than the threshold distance away, and/or the controller determines that the assisting vehicle has not yet arrived at the location of the transmitting vehicle, then the method 400 may return to 430 and continue to transmit the alert at the lower second frequency. Thus, the transmitting vehicle may continue to transmit the alert until an assisting vehicle arrives at the geographical location of the transmitting vehicle. Once the assisting vehicle arrives at the location of the transmitting vehicle, method 400 may continue from 434 to 436 and the transmitting vehicle may stop transmitting the alert. Method 400 then returns.

In this way, a communications system for an on-road vehicle may comprise a transceiver capable of sending and receiving wireless signals, a display screen, a processor, and a storage device. The storage device may storing instructions executable by the processor to: generate an alert in response to detecting alert conditions, determine an alert type of the alert based on the one or more alert conditions, in response to determining that the alert type is a first type comprising a request for assistance, transmit the alert via the transceiver a threshold distance until a confirmation of assistance is received by the transceiver, and in response to determining that the alert type is a second type, different from the first type, transmit the alert via the transceiver for a predetermined duration. In a first example of the communication system, the alert may comprise a package of data encoding one or more of a geographical location of the vehicle, the alert type, alert details, road conditions, inclement weather, vehicle operator information, vehicle make, vehicle model, and vehicle year. In a second example of the communication system, the request for assistance may be a request for a third party external to the vehicle to provide assistance to the vehicle in the event of one or more of an impact, accident, mechanical and/or electrical failure of the vehicle, and medical emergency of a vehicle occupant of the vehicle. In a third example of the communications system, the confirmation of assistance may comprise a package of data encoding a message confirming that a third party external to the vehicle is en route to a geographical location of the vehicle. In a fourth example of the communication system, the wireless signals may comprise one or more of Wifi, Bluetooth, and radio waves. In a fifth example of the communications system, the storage device may further include instructions executable by the processor to stop transmitting the alert in response to receiving the confirmation of assistance. In a sixth example of the communication system, the storage device may further include instructions executable by the processor to, in a second mode, display a received alert to a vehicle user via the display screen in response to receiving the received alert via the transceiver, and display a route to the vehicle user in response to a determination that the alert is a request for assistance, the route providing directions to a location from which the received alert was transmitted. In a seventh example of the communication system, the system may further comprise a remote server in wireless communication with the vehicle, the remote server comprising a processor and a storage device storing instructions executable by the processor to: responsive to receipt of an alert from a first vehicle of the plurality of vehicles, broadcast the alert to one or more vehicles of the plurality of vehicles within a threshold radial distance of the first vehicle. In an eighth example of the communications system, the predetermined duration may include one or more of a number of engine cycles, an amount of time, and a distance travelled by the vehicle.

Focusing now on FIG. 4B, it shows an example method 450 for broadcasting alerts when the vehicle is in wireless communication with the one or more remote servers. Thus, as described above with reference to FIG. 4A, method 450 may be executed by the remote servers in response to receiving an alert sent from the transmitting vehicle. Instructions for carrying out method 400 may be stored in non-transitory memory (e.g., data-holding subsystem 84 shown in FIG. 1) of the remote servers. As such, method 450 may be executed by the one or more remote servers based on the stored instructions and in conjunction with signals received from the one or more vehicles. The remote servers may employ a communication system (e.g., communication subsystem 88 shown in FIG. 1) to transmit a wireless signal to other vehicles in the same or similar geographic area as the transmitting vehicle from which the alert was received.

As such, method 450 may begin at 440 by receiving the alert from the transmitting vehicle. Thus, the one or more remote servers may receive an indication that the transmitting vehicle has detected alert conditions based on signals received from the transmitting vehicle at 440. As described above with reference to FIG. 4A, the transmitting vehicle may transmit wireless signals to the one or more remote servers, requesting that the alert be transmitted to vehicles and/or third parties external to the transmitting vehicle. Upon receipt of a request for transmittal of the alert from the transmitting vehicle and/or upon identification that alert conditions exist at the transmitting vehicle, the one or more remote servers may then determine the alert type and/or user request at 442, in the same or similar manner as described above 418 with reference to FIG. 4A. Further, the one or more remote servers may then proceed to 444 from 442 and determine the desired recipients of the alert based on the alert type and the user request in the same or similar manner as described at 414 with reference above to FIG. 4A.

After determining the desired recipients of the alert at 414, the method 450 may continue to 446 which comprises transmitting the alert to the desired recipients of the alert within a smaller first transmission radius or range from the transmitting vehicle. Thus, the one or more remote servers, may broadcast the alert received from the transmitting vehicle, to desired recipients of the alert within the smaller first distance to the transmitting vehicle. In some examples, the desired recipients may be all vehicles within the smaller first distance of the transmitting vehicle. However, in other examples, the desired recipient may only be vehicles whose user preferences match to the alert generated by the transmitting vehicle. Thus, as described below with reference to FIG. 5, a vehicle user may input preferences to only elect to receive or be displayed with certain types of alerts.

Method 450 may then continue from 446 to 448 which comprises receiving location information from vehicles outside of the transmissions radius and transmitting the alert to vehicles about to enter or entering the transmission radius. Thus, based on the location information received from vehicles travelling outside of the transmission radius (e.g., smaller first radius described in 446), the one or more remote servers may send the alert to any one or more vehicles that are predicted to enter the transmission radius. In this way, a vehicle outside of the transmission radius may be given notice of the alert, prior to entering the transmission radius.

Next, the method 450 may proceed from 448 to 451 which comprises determining if the alert type is an assistance request in the same or similar manner as described above with reference to 420 of FIG. 4A.

If it is determined at 451 that the alert type is not an assistance request, then method 450 may continue to 452 which comprises stopping transmittal of the alert after a threshold duration since the initiation of transmittal of the alert and/or after the vehicle has travelled more than a threshold distance from where it originally broadcast the alert to the one or more remote servers. Method 450 may then return.

However, if it is determined at 451 that the alert type is an assistance request, then method 450 may continue from 451 to 454 which comprises determining if confirmation of assistance has been received in the same or similar manner to that of 424 of FIG. 4A. Thus, in one example, an assisting vehicle may transmit a confirmation of assistance via wireless signals, directly to the transmitting vehicle as in 424 of FIG. 4A. The transmitting vehicle may then send the confirmation to the one or more remote servers. However, in other examples, the assisting vehicle may send the confirmation of assistance via wireless signals to the one or more remote servers, which may then communicate the confirmation to the transmitting vehicle requesting assistance.

If confirmation of assistance has been received at 454, then method 450 may continue to 456 which comprises determining if the severity of the alert is greater than a threshold in the same or similar manner to that of 428 in FIG. 4A. If the severity of the alert is not greater than the threshold, then the method 450 may continue to 458, and the one or more remote servers may stop transmitting the alert. Method 450 may then return. Method 500 at 458 may additionally comprise transmitting a route to the assisting vehicle providing directions from the geographic location of the assisting vehicle to the geographic location of the transmitting vehicle requesting assistance. Thus, the server may in some examples, receive the geographic locations of both the assisting vehicle and the transmitting vehicle via the navigation modules (e.g., navigation module 40 shown in FIG. 1) included in each of the vehicles. The server may then plot a route for directing the assisting vehicle to the geographic location of the transmitting vehicle, and may wirelessly send this route information to the assisting vehicle in a data package, so that the route may be displayed to one or more vehicle occupants of the assisting vehicle via a display screen (e.g., display screen 108 shown in FIG. 2) of the assisting vehicle.

Additionally, in some examples, the remote server may send signals to the transmitting vehicle, indicating that the assisting vehicle is en route to the geographic location of the transmitting vehicle. Further, the remote server may send signals to the transmitting vehicle, indicating a distance between the assisting vehicle and the transmitting vehicle, and an estimated time of arrival of the assisting vehicle at the geographic location of the transmitting vehicle.

However, if at 456 it is determined that the severity of the alert is greater than the threshold, then the one or more servers may continue to transmit the alert and may adjust the frequency of transmittal based on changes in the assisting vehicle's proximity in the same of similar manner to that described above with reference to 430 of FIG. 4A. Thus, the assisting vehicle may transmit its geographical coordinates to the one or more remote servers, and the one or more remote servers may in turn monitor the progress of the assisting vehicle towards arriving at the geographical location of the transmitting vehicle.

Based on the distance between the assisting vehicle and the transmitting vehicle, the one or more remote servers may determine if the assisting vehicle has arrived at the geographical location of the transmitting vehicle at 462. If the assisting vehicle has not arrived at the location of the transmitting vehicle, the one or more remote servers may return to 460 and continue to transmit the alert at a frequency dependent on the distance between the two vehicles.

However, if the one or more remote servers determines that the assisting vehicle has arrived at the geographical location of the transmitting vehicle at 462, method 450 may then continue to 458 and the one or more remote servers may stop transmitting the alert. Method 450 may then return.

Returning to 454, if it is determined that a confirmation of assistance has not been received, method 450 may continue to 464, which comprises determining if a threshold duration has passed without receipt of a confirmation of assistance. Thus, the method at 464 may include determining an amount of time that has passed since the commencement of the alert signal transmission. If the one or more remote servers has been transmitting the alert for more than the threshold duration without receiving a confirmation of assistance, then method 450 may continue to 468. At 468, the one or more remote servers may increase the transmission radius of the alert. Thus, the distance away from the transmitting vehicle that the alert is broadcast may be increased from the smaller first radius to a larger second radius. In some examples, the smaller first radius may be approximately 1 km. However, in other examples, the smaller first radius may be any radius in a range of radii from 0.5 km to 4 km. The larger second radius may be approximately 2 km. However, in other examples, the larger second radius may be any radius in a range of radii from 2 km to 8 km.

Thus, the server may increase the transmission range of the alert, so that the distance from the transmitting vehicle to which the alert is broadcast is increased in response to a threshold duration passing since the onset of the alert transmission without a receipt of an assistance confirmation. In some examples, the transmission radius may be increased only from the smaller first radius to the larger second radius. However, in still further examples, the transmission radius may continue to be increased for each successive threshold duration interval that passes without receipt of a confirmation of assistance. Thus, if the threshold duration passes multiple times, with no confirmation of assistance received, then at each instance of the threshold duration passing without receipt of confirmation of assistance, the one or more remote servers may incrementally increase the radius of transmission until a confirmation of assistance is received.

Thus, method 450 may continue from 468 to 466 which comprises continuing to transmit the alert until a confirmation of assistance is received. Thus, method 450 may return to 454 from 466 and continue to check to see if a confirmation of assistance has been received. Once a confirmation of assistance is received, method 450 may continue to 456, and proceed with method 450 as described above. Method 450 may alternatively proceed directly to 466 from 464 if the threshold duration has not passed with no confirmation received.

In this way, a method for a vehicle communications system, may comprise broadcasting an alert to within a smaller first threshold distance of a first vehicle for a duration in response to detecting alert conditions at the first vehicle, broadcasting the alert to within a larger second threshold distance of the first vehicle in response to the duration passing without receipt of a confirmation of assistance, and responsive to receipt of the confirmation of assistance from a second vehicle, generating a route providing directions from a geographic location of the second vehicle to a geographic location of the first vehicle, and transmitting the route to one or more users of the second vehicle for display to one or more occupants of the second vehicle. In a first example of the method, the alert conditions may be detected based on wireless signals received from the first vehicle, the wireless signals encoding data relating to operating conditions of the first vehicle such as vehicle speed, impact force, engine speed, body deformation, air bag deployment, mechanical failure, electrical failure, medical emergency of a vehicle occupant, inclement weather, road hazards, road conditions, and environmental conditions. In a second example of the method, the broadcasting the alert may comprise wirelessly transmitting a data package encoding the alert via a remote server in wireless communication with the first vehicle and the second vehicle. In a third example of the method, wireless communication between the remote server and the first vehicle and the second vehicle may be provided via one or more relay towers, where the relay towers propagate wireless signals produced by one or more of the first vehicle, second vehicle, and remote server. In a fourth example of the method, the method may include any of the one or more of the previously introduced examples of the method and may additionally comprise, ceasing to broadcast the alert in response to the second vehicle arriving at the geographic location of the first vehicle. In a fifth example of the method, the method may include any of the one or more of the previously introduced examples of the method and may additionally comprise adjusting a frequency at which the alert is broadcast based on changes in a distance between the first vehicle and the second vehicle, where the frequency is reduced for decreases in the distance between the first vehicle and the second vehicle.

Turning now to FIG. 5, it shows a method 500 for displaying alerts to a vehicle occupant, and in the case of the alert being a request for assistance, the method 500 may be executed to guide a vehicle occupant to the transmitting vehicle requesting assistance. Thus, as described above with reference to FIGS. 4A and 4B, method 500 may be executed by one or more vehicles in response to receiving an alert sent from the transmitting vehicle. Instructions for carrying out method 500 may be stored in non-transitory memory of a vehicle controller (e.g., operating system processor 214 shown in FIG. 3). As such, method 400 may be executed by the controller based on the stored instructions and in conjunction with wireless signals received from other vehicles such as any of the vehicles 12 shown above with reference to FIG. 1 capable or sending electromagnetic waves such as Wifi, Bluetooth, radio, etc. The controller may employ a communication system (e.g., external device interface 212 shown in FIG. 3, or telematics unit 30 shown in FIG. 1) to transmit a wireless signal to other vehicles in the same or similar geographic area and/or to the remote servers.

Method 500 begins at 502 by receiving and/or storing user preference via an input device (e.g., pushbuttons 34 shown in FIG. 1, display screen 108 shown in FIG. 2, user interface 218 shown in FIG. 3, etc.). Thus, a vehicle occupant of the vehicle (e.g., operator, passenger, etc.) may input preferences via the input device at 502. The preferences may include desired types of alerts and/or desired conditions under which to receive alerts. As described above with reference to FIGS. 4A-4B an alert may be generated by a vehicle, and may be transmitted to other vehicles via wireless signals. The user of a vehicle may elect to only receive alerts of certain types, or alerts generated under certain vehicle operating conditions, or alerts generated within a threshold distance, etc. For example, the user may elect to only receive alerts pertaining to the current weather. In other examples, the user may elect to only receive requests for assistance.

In still further examples, as described above with reference to FIG. 4A, a vehicle occupant may store pre-set conditions which if satisfied, then requires authorization from one or more vehicle occupants before the alert may be transmitted. For example, a vehicle occupant may elect to require authorization before transmitting an alert that was initially triggered by their own inputs, and/or inputs from another vehicle occupant. In other examples, the pre-set conditions may include alert conditions that do not include one or more of a vehicle impact, occupant medical emergency, air bag deployment, etc. Thus, the pre-set conditions may include conditions where the severity of the alert is less than a threshold. As such, a vehicle occupant may elect to require authorization from one or more vehicle occupants before transmitting an alert to parties external to the vehicle.

Method 500 may then continue from 502 to 504 which comprises determining if an alert has been received. Thus, the controller may determine if the communications system has received an alert from another vehicle and/or from the one or more remote servers. If it is determined at 504 that an alert has not been received, then the method 500 may continue to 508 and an alert may not be displayed to one or more vehicle occupants via a user display (e.g., touch screen 108 shown in FIG. 2). Method 500 may then return.

However, if an alert is received at 504, method 500 may continue from 504 to 506, which comprises determining if the alert matches the user preferences. If the alert does not match with the user selected preferences, then the method 500 may continue to 508 and the alert may not be displayed to one or more vehicle occupants. For example, if the user preferences include only displaying requests for assistance, and the alert relates to inclement weather, then the controller may not send signals to the user display to present the alert to the one or more vehicle occupants. Method 500 then returns.

On the other hand, if the alert matches the user preferences at 506, then method 500 may continue from 506 to 510 which comprises displaying the alert to the one or more vehicle occupants via the user display. Thus, the controller may send signals to the user display to present the alert to the one or more vehicle occupants if the alert matches with the user preferences. In some examples, if the one or more vehicle occupants has not set any user preferences, or if the one or more vehicle occupants elects to be notified of all alerts received by the controller, then every alert received by the controller may be displayed to the one or more vehicle occupants at 510.

Method 500 may then proceed from 510 to 512 which comprises determining the alert type in the same or similar manner as described above with reference to 418 of FIG. 4A. After determining the alert type at 512, method 500 may continue to 514 which comprises determining if the alert type is an assistance request in the same or similar manner as described above with reference to 420 of FIG. 4A.

If the alert type is not an assistance request then the controller may send signals to the user display to display the alert to the one or more vehicle occupants at 515. Method 500 may then return. Thus, if the alert is information regarding inclement weather, road conditions, hazards, etc., then the alert may be displayed to the one or more vehicle occupants and then method 500 may return.

However, if the alert is an assistance request, then the method may continue from 514 to 516 which comprises displaying a confirmation message to the one or more vehicle occupants for authorization. Thus, the confirmation message may be displayed to the one or more vehicle occupants to query the one or more vehicle occupants as to whether or not they wish to respond to the assistance request, and provide assistance to the transmitting vehicle. For example, the confirmation message may include text such as “DO YOU WISH TO PROVIDE ASSISTANCE?” to which the one or more vehicle occupants may respond via the touch screen or buttons, or various other input devices.

As such, method 500 may continue from 516 to 518 which comprises determining if the one or more vehicle occupants wish to provide assistance to the transmitting vehicle. The one or more vehicle occupants may indicate whether or not they authorize a provision of assistance via the user inputs. If the one or more vehicle occupants indicate via the user inputs, that they do not wish to provide assistance to the transmitting vehicle, then the controller may proceed to 520 and the controller does not send confirmation of assistance to the transmitting vehicle and/or one or more remote servers. Method 500 then returns.

However, if the one or more vehicle occupants indicate that they wish to provide assistance to the transmitting vehicle, then method 500 may continue from 518 to 522 which comprises sending confirmation message via a wireless signal to one or more of the remote servers and transmitting vehicle. Thus, the controller may send signals to the communication system to send wireless signals which include data relating to the confirmation message. The confirmation message may include text, voice, or other call data, which indicates that the user has received the assistance request, and is en route to the geographical location of the transmitting vehicle.

In some examples, the confirmation message may be transmitted via a transceiver (e.g., transceiver 30 shown in FIG. 1) for a duration. The duration may be a pre-set amount time, number of engine cycles, etc., since receipt of the alert. In other examples, the confirmation message may be transmitted a pre-set number of times, each transmission separated by a pre-set interval. The interval may be an amount of time, number of engine cycles, etc. In still further examples, the assisting vehicle may continue to transmit the confirmation message until the assisting vehicle is within a threshold distance of the transmitting vehicle. Thus, the assisting vehicle may in some examples, continue to transmit the confirmation message until the assisting vehicle has reached the geographical location of the transmitting vehicle.

As described above, the assistance request may include the geographical coordinates of the transmitting vehicle. Thus, the method 500 may continue from 522 to 524, and may display a route to the one or more vehicle occupants for traveling to the transmitting vehicle from which the alert was received. For example, the vehicle may include a navigation system (e.g., navigation module 40 shown in FIG. 1), which may generate a route to reach the transmitting vehicle from the current position of the user based on the geographical coordinates of the transmitting vehicle received in the alert. The route may be displayed to the user via the display screen. Method 500 may then return.

In this way, a communications system for an on-road vehicle may comprise: a transceiver capable of wirelessly sending and receiving data packets encoding one or more of an alert and a confirmation of assistance, a display screen, a user interface for receiving inputs from a vehicle user, a processor, and a storage device storing instructions executable by the processor. The instructions stored on the storage device may be executable by the processor to: responsive to receiving an alert from a source external to the on-road vehicle, determine a geographic location from which the alert was transmitted, display the alert to the vehicle user via the display screen, and in response to input from the vehicle user authorizing a provision of assistance, display a route providing directions to the geographic location from which the alert was transmitted, and transmit, to the geographic location from which the alert was transmitted, a confirmation of assistance via the transceiver for a duration. In a first example, the storage device may further include instructions executable by the processor to stop transmitting the confirmation of assistance after a threshold duration, the threshold duration being one or more of a number of engine cycles, amount of time, and distance travelled by the vehicle. Additionally or alternatively, the storage device may include instructions executable by the processor to stop transmitting the confirmation of assistance when the vehicle arrives at the geographic location from which the alert was transmitted. In some examples, the alert may comprise a package of data encoding one or more of an assistance request, and the geographical location from which the alert was transmitted. The confirmation of assistance may in some example include a package of data encoding a message confirming that the on-road vehicle is en route to the geographical location from which the alert was transmitted.

In this way, an inter-vehicle communications system may enable wireless communication between vehicles in the same or similar geographic area. Further, by including transceivers capable of both sending and receiving wireless signals in the vehicles, communication between vehicles may be maintained both when the vehicles are in communication with a wireless carrier network such as a cellular service provider, as well as when the vehicles are not in communication with the wireless carrier network. Thus, if a vehicle enters a geographic area in which there is limited or substantially no cellular reception, the vehicle may still communicate with other vehicles in the same or similar geographic area by transmitting wireless signals to vehicles within the transmission range of the transceiver.

Upon encountering a road hazard, road work, inclement weather, etc., a vehicle may broadcast this information to other vehicles in the surrounding area, and/or to vehicles that may enter the same geographic area. In this way, vehicles may be provided with details of upcoming road, weather, traffic, or other conditions.

Further, in the event of an impact, accident, mechanical failure, electrical failure, or medical emergency, an assistance request may be broadcast to nearby vehicles to notify them of a need for assistance. The assistance request may include the geographical coordinates or location of the vehicle broadcasting the assistance request, so that nearby vehicles may travel to and/or assist the vehicle. In some examples, services such as ambulances, tow trucks, police, etc., may be notified of the location of the vehicle requesting assistance, so that they may provide assistance.

Thus, a technical effect of increasing inter-vehicle communication is achieved by providing transceivers in one or more vehicles. By increasing inter-vehicle communication, vehicles may be notified of upcoming road and/or environmental conditions, so that vehicle operators may plan and/or proceed accordingly. Further, in the event of an impact, accident, medical emergency, etc., nearby vehicles may be alerted and/or guided to the site of the crash, accident, medical emergency.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the in-vehicle computing system 109 and/or talker 202/listener 204 described with reference to FIGS. 2 and 3. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A communications system for an on-road vehicle, the system comprising:
a transceiver capable of sending and receiving wireless signals;
a display screen;
a processor; and
a storage device storing instructions executable by the processor to:
generate an alert in response to detecting alert conditions;
determine an alert type of the alert based on the alert conditions;
in response to determining that the alert type is a first type comprising a request for assistance, transmit the alert via the transceiver a threshold distance until a confirmation of assistance is received by the transceiver; and
in response to determining that the alert type is a second type, different from the first type, transmit the alert via the transceiver for a predetermined duration;
wherein the transmitting is performed automatically, without user confirmation, if the alert type corresponds to a predefined alert type.

2. The system of claim 1, wherein the alert comprises a package of data encoding one or more of a geographical location of the vehicle, the alert type, alert details, road conditions, inclement weather, vehicle operator information, vehicle make, vehicle model, and vehicle year, wherein the instructions further specify requesting a user confirmation in response to the alert type not corresponding to the predefined alert type, and wherein the transmitting is performed in response to receiving the user confirmation.

3. The system of claim 2, wherein the request for assistance is a request for a third party external to the vehicle to provide assistance to the vehicle in the event of one or more of an impact, accident, mechanical and/or electrical failure of the vehicle, and medical emergency of a vehicle occupant of the vehicle, and wherein the predefined alert type comprises one or more user-selected alert types.

4. The system of claim 1, wherein the confirmation of assistance comprises a package of data encoding a message confirming that a third party external to the vehicle is en route to a geographical location of the vehicle.

5. The system of claim 2, wherein the wireless signals comprise one or more of Wifi, Bluetooth, and radio waves, and wherein the predefined alert type comprises a collision event in which a collision impact corresponding to the collision event is above a threshold.

6. The system of claim 1, wherein the storage device further includes instructions executable by the processor to:
stop transmitting the alert in response to receiving the confirmation of assistance if a severity of the alert is below a threshold; and
continue transmitting the alert in response to receiving the confirmation of assistance if the severity of the alert is above the threshold.

7. The system of claim 1, wherein the storage device further includes instructions executable by the processor to:
in a second mode, display a received alert to a vehicle user via the display screen in response to receiving the received alert via the transceiver; and
display a route to the vehicle user in response to a determination that the alert is a request for assistance, the route providing directions to a location from which the received alert was transmitted.

8. The system of claim 1, further comprising a remote server in wireless communication with the vehicle, the remote server comprising:
a processor; and
a storage device storing instructions executable by the processor to:
responsive to receipt of an alert from a first vehicle of a plurality of vehicles, broadcast the alert to one or more vehicles of the plurality of vehicles within a threshold radial distance of the first vehicle.

9. The system of claim 6, wherein the predetermined duration includes one or more of a number of engine cycles, an amount of time, and a distance travelled by the vehicle, and wherein the severity is based on one or more of a weather condition, a collision impact level, a user medical condition, or a user input.

10. A method for a vehicle communications system, the method comprising:
broadcasting an alert within a smaller first threshold distance of a first vehicle for a duration in response to detecting alert conditions at the first vehicle;
broadcasting the alert within a larger second threshold distance of the first vehicle in response to the duration passing without receipt of a confirmation of assistance; and
responsive to receipt of the confirmation of assistance from a second vehicle, generating a route providing directions from a geographic location of the second vehicle to a geographic location of the first vehicle, and transmitting the route to one or more users of the second vehicle for display to one or more occupants of the second vehicle;
wherein the broadcasting is performed automatically, without user confirmation, in response to the alert being of a predetermined alert type; and
wherein the broadcasting is performed in response to user confirmation, in response to the alert not being of the predetermined alert type.

11. The method of claim 10, wherein the alert conditions are detected based on wireless signals received from the first vehicle, the wireless signals encoding data relating to operating conditions of the first vehicle such as vehicle speed, impact force, engine speed, body deformation, air bag deployment, mechanical failure, electrical failure, medical emergency of a vehicle occupant, inclement weather, road hazards, road conditions, and environmental conditions.

12. The method of claim 10, wherein the broadcasting the alert comprises wirelessly transmitting a data package encoding the alert via a remote server in wireless communication with the first vehicle and the second vehicle, and further comprising, in response to the confirmation of assistance being received, continuing to broadcast the alert if a severity of the alert is above a threshold and ceasing to broadcast the alert if the severity is below the threshold.

13. The method of claim 12, wherein wireless communication between the remote server and the first vehicle and the second vehicle is provided via one or more relay towers, where the relay towers propagate wireless signals produced by one or more of the first vehicle, second vehicle, and remote server, and wherein the severity is based on one or more of a weather condition, a collision impact level, a user medical condition, or a user input.

14. The method of claim 10, further comprising, ceasing to broadcast the alert in response to the second vehicle arriving at the geographic location of the first vehicle, and wherein the predetermined alert type comprises one or more user-selected alert types.

15. The method of claim 10, further comprising adjusting a frequency at which the alert is broadcast based on changes in a distance between the first vehicle and the second vehicle, where the frequency is reduced for decreases in the distance between the first vehicle and the second vehicle, and wherein the predetermined alert type includes a collision alert in which a collision impact is above a threshold, the collision impact estimated based on one or more accelerometers.

16. A communications system for an on-road vehicle, the system comprising:
a transceiver capable of wirelessly sending and receiving data packets encoding one or more of an alert and a confirmation of assistance;
a display screen;
a user interface for receiving inputs from a vehicle user;
a processor; and
a storage device storing instructions executable by the processor to:
responsive to receiving an alert from a source external to the on-road vehicle:
determine a geographic location from which the alert was transmitted; and
display the alert to the vehicle user via the display screen; and
in response to input from the vehicle user authorizing a provision of assistance:
display a route providing directions to the geographic location from which the alert was transmitted; and
transmit, to the geographic location from which the alert was transmitted, a confirmation of assistance via the transceiver for a duration;
wherein the received alert corresponds to a user-selected alert type.

17. The system of claim 16, wherein the storage device further includes instructions executable by the processor to:
stop transmitting the confirmation of assistance after a threshold duration, the threshold duration being one or more of a number of engine cycles, amount of time, and distance travelled by the vehicle.

18. The system of claim 16, wherein the storage device further includes instructions executable by the processor to:
stop transmitting the confirmation of assistance when the vehicle arrives at the geographic location from which the alert was transmitted.

19. The system of claim 16, wherein the alert comprises a package of data encoding one or more of an assistance request, and the geographical location from which the alert was transmitted, and
wherein the user-selected alert type is one or more of alerts generated under certain operating conditions, alerts generated within a threshold distance, weather alerts, or requests for assistance.

20. The system of claim 16, wherein the confirmation of assistance comprises a package of data encoding a message confirming that the on-road vehicle is en route to the geographical location from which the alert was transmitted, and
wherein the instructions further specify not receiving alerts which do not correspond to the user-selected alert type.
